(19) United States
(12) Patent Application Publication
(10) Pub. No.: US 2016/0272109 A1
(43) Pub. Date: Sep. 22, 2016

(54) LINEAR FLEXIBLE LED FIXTURE FOR LIFT TRUCKS

(71) Applicant: Robert William Harrison, Caledon (CA)

(72) Inventor: Robert William Harrison, Caledon (CA)

(21) Appl. No.: 14/664,315

(22) Filed: Mar. 20, 2015

(51) Int. Cl. B60Q 1/26; F21V 31/00; F21V 9/00; F21S 4/00

(52) U.S. Cl. CPC B60Q 1/2615; F21S 4/001; F21V 31/00; F21V 9/00; F21Y 2101/02

(57) ABSTRACT

The present invention relates to a linear, substantially semi-rigid flexible aimable light fixture removably mountable on lift trucks, the fixture comprising: a linear strip of light emitting diodes (LED) affixed to a backing support member. The LED lights are disposed within a flexible/arch-able, water-submergible and shatter proof housing member comprising a lens pipe made of an extruded PVC material. The fixture further comprises a filter layer between the light source and the housing member, for controlling harshness of light and a connector adapted to connect the light source to a pre-existing power source or lighting unit.

### FIELD OF THE INVENTION

The present invention generally relates to lighting systems and more specifically relates to a linear, semi-rigid, flexible/arch-able, water-submergible LED fixture removably mountable on different types of structures and surfaces including vehicles such as lift trucks.

### BACKGROUND OF THE INVENTION

Lighting systems, especially for installation in vehicles involves consideration of various parameters such as fixture mounting height, spacing, beam pattern, light level, brightness control, aimability and other similar parameters. In addition, the installation of conventional lighting systems including headlights for load handling vehicles such as lift trucks may be costly and cumbersome due to the expenses incurred on light accessories, complexity of wiring and its integration with power source.

Current industry options trend towards a single, brilliant headlight assembly typically mounted on the front top corners of lift truck overhead guards. One of the drawbacks of conventional lights is that the light beam gets reflected harshly from mast assembly, an integral part of the lift truck that is located between the operator's cabin and the intended viewing area (focal area). The harsh reflection of light from the mast assembly causes the operator's eyes to involuntarily constrict, thus interfering with some of the desired reflections from focal area entering into the operator's eye, causing poor visibility. Door mounted dock-lights also cause the same negative effect on the operator's visibility of focal area, especially when driving the vehicle in reverse.

With the advent of LED (light emitting diode), it became possible for lights to be integrated into smaller profile fixtures on different locations. LEDs forms small light sources which comprises a two lead semiconductor that emits light when activated. LED lamps have a longer life span and the ability to emit high-brightness light, with a more energy saving advantage in today's scenario of increasingly scarce energy.

The increasing adoption and advancement of LED technology has resulted in the development of new LED lighting devices which may replace conventional lamps or light bulbs. Linear LED lighting is becoming more popular as LEDs continue to improve in efficiency and cost. Conventional lighting fixtures for vehicles suffers from limitations due to certain characteristics and qualities of lighting devices, for example, these lighting devices require a lot of power and generate a lot of heat.

In addition, conventional lighting devices are relatively large and rigid or fixed structures which are positioned to emit light beam from a single point. This may result in restricted applications of such fixtures and it also causes unwanted reflection of light rays bouncing from objects or from vehicle parts itself. Lighting fixtures, especially for vehicles, are expected to withstand harsher environmental conditions including exposure to water, heat, dust and high pressure impact. Some of the existing water proof fixtures are resistant to water only to a certain extent such as splash proof fixtures. Further, conventional lighting fixtures with different wiring patterns makes it difficult to integrate a new lighting unit with already installed lighting systems or to a pre-existing power supply assembly.

Furthermore, existing flexible lights including LED strips or ribbons are either being covered by clear vinyl type lens tubes which are too flaccid or being affixed to fixtures that are too rigid. The flexible LED fixtures needs to be arch-able for securing onto vehicle structures of different shapes such straight, curved structures. Moreover the LED fixtures needs to be mounted securely where drilling is not a feasible option for mounting, for example vehicle structures such as overhead guards where drilling holes would affect the safety of these structures which are impact rated at the time of manufacture, yet to be aimable.

Accordingly, there exists a need for an improved, water-submergible, aimable, flexible and customizable light fixture that can be removably mountable on different types of surfaces including vehicle structures of lift trucks.

### SUMMARY OF THE INVENTION

The present invention relates to a linear, substantially flexible light fixture removably mountable on vehicles such as lift trucks, the fixture comprising a light source consisting a linear strip of light emitting diodes (LED) affixed to a backing support member. The light fixture further comprises a semi-rigid, flexible/arch-able, water-submergible housing made of a substantially translucent material encasing the light source fixed to the support member. The shape of the flexible housing member is further customizable using heat treatment, whenever required. An electrical connector for connecting the light source to a power source, the connector comprising a strain relief member allowing both positive and negative electrical leads to pass into and out of a same end of the fixture, allowing easy and quick installation. The light fixture comprises at least one mounting buckle adapted to removably mount the fixture on straight or curved surfaces while still facilitating direction aiming.

In an embodiment, the flexible/arch-able housing may comprise an additional light filter layer for controlling the harshness of light emitted from LED. The filter layer may comprise a substantially translucent material such as extruded PVC material.

In another embodiment, the electrical connector comprises a universal connector adapted to connect to a different lighting unit such as integrating with an existing lighting unit or to a pre-existing power supply. In an embodiment, the electrical connector may comprise two positive and two negative leads connected to the light source through the same end of the fixture via a strain relief member.

### BRIEF DESCRIPTION OF DRAWINGS

FIG. 1 is a perspective view of the flexible light fixture, according to an embodiment of the present invention.

FIG. 2 is a top view of the light source comprising a linear strip of LED lights according to an embodiment of the present invention.

FIG. 3 is a perspective view of the flexible light fixture mounted on front pillar of overhead guard of a lift truck, according to an embodiment of the invention.

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims Furthermore, in the following detailed description of the present invention, numerous specific details are set forth in order to provide a thorough understanding of the present invention. However, it will be evident to one of ordinary skill in the art that the present invention may be practiced without these specific details.

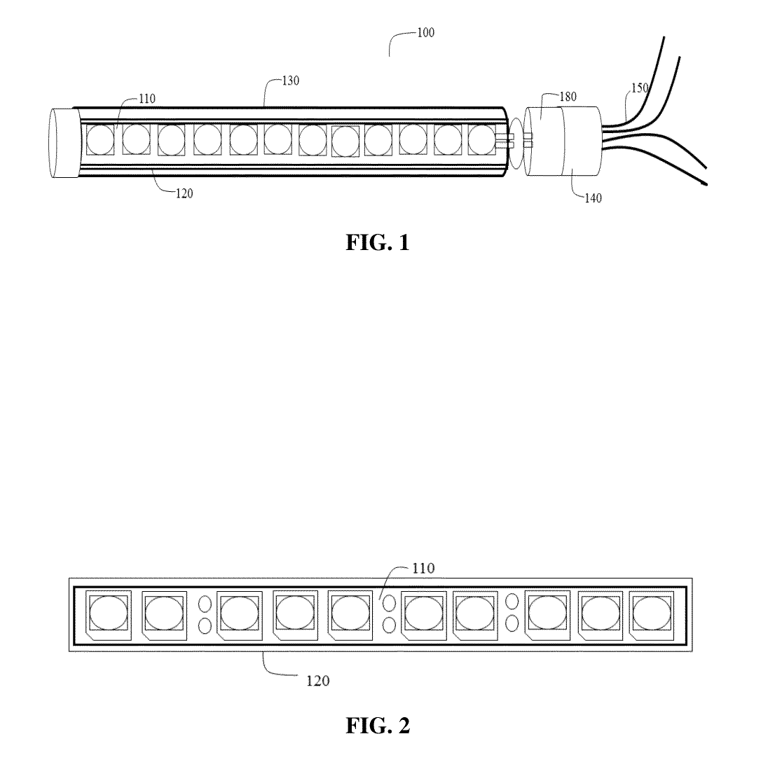

Referring to FIG. 1, which illustrates a perspective view of the semi-rigid flexible light fixture 100, comprising a light source 110 consisting a linear strip of light emitting diodes (LED) affixed to a backing support member 120. In an embodiment, the backing support member 120 comprises a substantially flexible plastic material, adapted to maintain the orientation of the LED strip 110 within the semi-rigid fixture 100. The light fixture 100 further comprises a flexible semi-rigid housing 130, made of a substantially translucent material, which encases the light source 110 fixed onto the backing support member 120. In an embodiment, the flexible semi-rigid housing 130 of the present light fixture is water resistant to a greater extent than conventional fixtures, rendering the present fixture water-submergible. In an embodiment, the flexible semi-rigid housing 130 shape may be further customizable using a heat gun or similar type of heat treatment, if required.

The light fixture 100 further comprises an electrical connector 140 adapted to connect the light source 110 to a power source (not shown) through electrical leads or wires 150. The electrical connector 140 comprises a strain relief member allowing both positive and negative electrical leads to pass into and out of a same end of the fixture, allowing easy and quick installation. The light fixture can be removably mounted on straight or curved surfaces such as overhead guard structures of lift trucks using one or more mounting buckles. These mounting buckles enable removable mounting of lighting fixtures on surfaces where drilling is not feasible, as well as aiming options.

A light filter layer (not shown) disposed within the housing 130, for controlling the harshness of light emitted from the LED light source 110. In an embodiment, the light filter layer may comprise a translucent PVC material, placed within the housing 130 and above the light source 110, such that an output of diffused light that is not too harsh, can be obtained.

In an embodiment, the flexible housing 130 comprises a lens pipe made of a clear extruded schedule 40 PVC (poly vinyl chloride) material, which is flexible/arch-able, shatter proof, water-submergible, and can be shaped further using a heat gun if required. In another embodiment, the lens pipe is made of a substantially translucent material or a frosted type PVC material.

The fixture assembly 100 further comprises an end cap for sealing one end of the fixture, while the other end is closed by the strain relief cap adapted to separately hold the electrical leads at one end of the lens pipe. The fixture assembly 100 is chemically welded together rendering the strain relief cap, lens pipe & end cap, as one hermetically sealed unit enclosing the LED strip or ribbon 110.

In an exemplary embodiment, silicone is injected behind the “button” isolator of the strain relief cap in order to seal the wires or leads coming in & out of the fixture and the button is then mechanically “tamped” to the back of the socket and cemented there when the lens pipe is installed permanently.

FIG. 2 is a top view of the light source comprising a linear strip of LED lights according to an embodiment of the present invention. The light source 110 comprises a linear strip of LED affixed to a backing support element 120, to maintain the orientation and to prevent the linear LED strip from stress caused during bending or stretching the fixture.

The linear LED strip requires a minimal 1 Ampere to power a LED strip of 32″ length. Typical voltage is 12 vdc but all available voltage options are plausible, including multiple input processors. The fixtures can be of varying length, colors and, brightness depending upon its functions. For example: LED of multiple colors can be used to denote multiple functions within a fixture, such as brakes, turning signal, running and 4-way flashers.

The electrical leads comprises wire conductor comprised of premium tinned copper strands with a high strand count. The lead further comprises pin contacts connecting the LED strip to existing power supply, or to a different lighting unit, the pins are installed perpendicularly through the wire, thus making contact with the copper, without damaging any of the copper strands within the wire covering. In an embodiment, the strain relief member houses two positive and two negative leads to pass into and out of a same end of the fixture. This type of design allows for easy integration with an existing light assemblies or lighting fixtures of a different type down-stream. The connectors of the flexible light fixture may comprise universal two pin plug and play type connectors which are commonly used in lighting systems of major brand lift truck vehicles, thus providing versatility of usage. The connectors can also be removed for hard wired installation as done in old model lift trucks.

The flexible light fixtures can be removably mounted on structures of any sit-down lift truck or counter-balanced lift truck or electric OR internal combustion engine, powered lift trucks with 3 or 4 wheel design using Pneumatic OR Cushion Tires, with an Overhead Guard (OHG). Flexible light fixture mountable structures on lift trucks may include but not limited to overhead guards, front and rear guard pillars and the like, of different shapes and sizes.

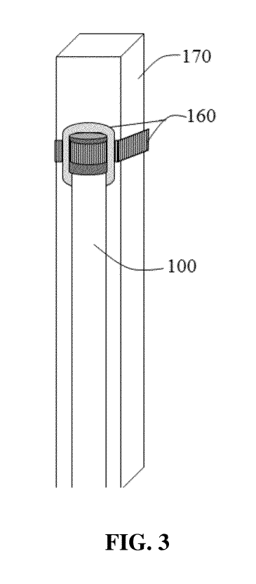

FIG. 3 shows a perspective view of the semi-rigid flexible light fixture mounted on a front pillar of overhead guard of a lift truck, according to an embodiment of the invention. The flexible lighting fixture assembly 100 is mounted to a square shaped guard pillar 170 using a mounting buckle 160. The flexible nature of the fixture assembly allows it to be mounted on structures of different shape and sizes including round, square, straight or curved structures using one or more mounting buckles, enabling aiming options.

In an embodiment, the semi-rigid flexible light fixture assembly is mountable on front guard pillars of a lift truck. The semi-rigid flexible light fixture assembly can also be mounted horizontally on one or more of the rear pillar of overhead guard facilitating illumination on rear side, but away from the truck thus providing adequate light for clear visibility to the operator while driving in reverse. This feature also eliminates the need for door mounted dock lights, which normally results in unwanted reflections towards operator eyes looking towards rear or through rear view mirror while driving in reverse direction.

The semi-rigid flexible light fixture assembly further comprises an information sleeve that could be inserted into the semi-rigid flexible housing. The information sleeve may comprise brand name, symbol, warning signs, number, vendor contact information or their combinations.

The semi-rigid flexible light fixture offers extremely high visibility of trucks by other vehicles and pedestrians, especially at aisle ends & intersections and while driving in reverse direction. The improved lighting fixture thus fosters safer, more accurate operation of vehicles such as the lift truck with less damage of product and/or incorrect shipments. The semi-rigid flexible/arch-able light fixture can be easily installed onto or uninstalled from vehicles such as lift trucks. Upon installation, the semi-rigid flexible light assembly provides a profound aesthetic improvement and modernized look to the vehicles.

In an embodiment, the light source may be optionally coupled to a luminance controller which is configured to automatically control the brightness of emitted light. The luminance controller comprises a photo sensor for sensing the environmental light or incident light and a processor to receive signal from photo sensor, wherein the photo sensor is coupled to the processor which in turn operably connected to the light source. The processor processes the signal regarding sensed environmental light and controls the brightness of the light source. For example, the brightness of LEDs are reduced automatically under a brighter or well illuminated environment and vice versa.

In addition to application as lighting system in lift trucks, the flexible lighting fixture of the present invention can be used in a variety of industries, especially under harsh operating conditions including but not limited to mining & timber; municipal utility repair applications; underwater welding/construction; marine applications; carwash industry; health/food/drug/veterinary industries where deep, systematic and/or regular disinfection procedures are required; cooler & deep freezer applications, emergency lighting applications; transit system lighting; solar lighting; exterior and/or Interior lighting; and aquarium/pet industries.

The present invention has been described with a preferred embodiment thereof and it is understood that many changes and modifications to the described embodiment can be carried out, without departing from the scope and the spirit of the invention that is intended to be limited only by the appended claims.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

1. A linear, substantially flexible light fixture removably mountable on lift trucks, the light fixture comprising:
a light source comprising a linear strip of light emitting diodes (LED) affixed to a substantially flexible backing support member;
a semi-rigid flexible, water-submergible housing member encasing the light source and the backing support member, wherein shape of the semi-rigid flexible housing member is customizable using heat treatment;
a filter layer between the light source and the semi-rigid flexible housing member, configured to control harshness of light emitted by the light source;
an electrical connector adapted to connect the light source to a power source, wherein the electrical connector comprises at least one strain relief member permitting both positive and negative electrical leads into and out of a same end of the fixture; and
at least one mounting buckle adapted to removably mount the fixture on straight or curved surfaces while providing aiming options.

2. The light fixture of claim 1, further comprises an information sleeve removably attached to an inner surface of the flexible housing member.

3. The light fixture of claim 1, is removably mountable on overhead guard pillars of lift trucks using one or more mounting buckles that allow aiming.

4. The light fixture of claim 1, wherein the connector comprises a set of two positive and two negative electrical leads, adapted to connect the light source to a power supply.

5. The light fixture of claim 1, wherein the connector is adapted to connect the light source to a pre-existing power supply assembly.

6. The light fixture of claim 1, wherein the backing support member comprises a linear strip of plastic material.

7. The light fixture of claim 1, wherein the flexible housing member is arch-able, water proof, explosion rated and shatterproof.

8. The light fixture of claim 1, wherein the flexible housing member comprises a substantially translucent material.

9. The light fixture of claim 1, wherein the strain relief member is attached to one end of the fixture.

10. The light fixture of claim 1, wherein the flexible housing, backing support and strain relief member are welded together into one hermetically sealed unit enclosing the light source.
